(19) United States
(12) Patent Application Publication
(10) Pub. No.: US 2025/0103274 A1
(43) Pub. Date: Mar. 27, 2025

(54) INTERACTION CONTROL METHOD FOR DETECTING A SETTING OBJECT IN A REAL-TIME IMAGE, ELECTRONIC DEVICE AND TERMINAL DEVICE CONNECTED THERETO BY COMMUNICATION, AND NON-TRANSITORY COMPUTER-READABLE RECORDING MEDIUM

(71) Applicant: COMPAL ELECTRONICS, INC., Taipei (TW)

(72) Inventors: CHIAO-TSU CHIANG, Taipei (TW); LI-HSIN CHEN, Taipei (TW); CHIEH-YU CHAN, Taipei (TW); SHIU-HANG LIN, Taipei (TW); MIN WEI, Taipei (TW); YA-FANG HSU, Taipei (TW)

(73) Assignee: COMPAL ELECTRONICS, INC., Taipei (TW)

(21) Appl. No.: 18/815,870

(22) Filed: Aug. 27, 2024

Related U.S. Application Data
(60) Provisional application No. 63/540,050, filed on Sep. 23, 2023.
(60) Provisional application No. 63/544,955, filed on Oct. 20, 2023.

(51) Int. Cl. G06F 3/16; A63H 3/36; G06V 40/10; G06V 40/20

(52) U.S. Cl. CPC G06F 3/165; A63H 3/36; G06V 40/10; G06V 40/20; A63H 2200/00

(57) ABSTRACT

An interaction control method for detecting a default object in a real-time image and an electronic device are introduced. The method includes steps of image recognition, interaction area setting, movement detection, and playing execution, wherein a default object, a reference object and a setting object are recognized by artificial intelligence in the real-time image, and the electronic device triggers a preset instruction corresponding to the interaction content corresponding to an interaction area by artificial intelligence to recognize a preset instruction corresponding to the interaction content of an interaction area, and the electronic device executes the preset instruction to play a sound response. A terminal device in communication connection with an electronic device and a non-transitory computer-readable recording medium are further provided.

### CROSS-REFERENCE TO RELATED APPLICATION

This non-provisional application claims priority under 35 U.S.C. § 119(e) on U.S. provisional Patent Application Nos. 63/540,050 and 63/544,955, filed on Sep. 23, 2023 and Oct. 20, 2023, respectively, the entire contents of which are hereby incorporated by reference.

### BACKGROUND OF THE INVENTION

### 1. Field of the Invention

The present disclosure provides an image detecting technology, and in particular an interaction control method for detecting a setting object in a real-time image, an electronic device and a terminal device connected thereto by communication, and a non-transitory computer-readable recording medium.

### 2. Description of the Related Art

During the growth process of young children, apart from eating and sleeping, most of the time is spent playing and learning. In the process, adults can guide them through teaching aids, such as using cards to let young children understand numerals or English letters; or, it is like reading with a storybook, allowing young children to fit in the story scenario to achieve the effect of playing and learning. When young children are playing and learning, it is common for young children to carry their favorite toys, such as dolls, with them, just like friends.

In the prior art, even if the teaching aids such as cards and storybooks can be audio and can be used with accessories to have interaction effects, this is limited to the factory-set functions of the teaching aids themselves. It is easy for young children to gradually feel monotonous and boring, which greatly reduces the effect of playing and learning; moreover, when young children hold their favorite toys, they often rely on their own imagination to interact with the toys, and the prior art cannot systematically make the toys fit in the content of the teaching aids.

Therefore, the present disclosure aims to solve the problem of above-mentioned the prior art.

### BRIEF SUMMARY OF THE INVENTION

To solve the above-mentioned problem, the inventor provides an interaction control method for detecting a setting object in a real-time image, an electronic device, a terminal device connected thereto by communication, and a non-transitory computer-readable recording medium, image detection is performed to the movement of the setting object through the real-time image taken, and a corresponding interaction response is generated according to the result of the movement, so that the default object can interact with the setting object.

In order to achieve the above objective, the present disclosure provides an interaction control method for detecting a setting object in a real-time image, executed by an electronic device reading an executable code, and the electronic device executes the following steps: image recognition: recognizing a default object, a reference object and a setting object at the same time by artificial intelligence in the real-time image taken by a photographic unit of the electronic device; interaction area setting: setting a plurality of interaction areas according to the range occupied by the reference object in the real-time image by the electronic device, and each interaction area corresponds to an interaction content; movement detection: recognizing the default object holding the setting object in the real-time image with artificial intelligence, and detecting the movement of the setting object between the plurality of interaction areas on the reference object, and when the movement meets a preset condition, the electronic device triggers a preset instruction corresponding to the interaction content; and playing execution, executing the preset instruction by the electronic device for playing a sound response.

In one embodiment, in the step of image recognition, a first target frame covering the default object is defined, and a second target frame covering the setting object is defined; in the step of movement detection, when the first target frame and the second target frame intersect, the default object is confirmed to hold the setting object in the real-time image, and the movement of the setting object is detecting a movement trajectory of a center point of the second target frame, and includes detecting a relative change in the area size of the second target frame.

In one embodiment, in the step of movement detection, when the setting object is detected to have a movement from one of the interaction areas to another one of the interaction areas, or is detected to move from one of the interaction areas to another one of the interaction areas and stay for a predetermined time, it is regarded to meet the preset condition.

In one embodiment, a step of event setting is further included, the step of event setting is setting an interaction event to connect a plurality of interaction contents with relevance in series, the preset instructions corresponding to the plurality of interaction contents with relevance are triggered sequentially or randomly according to the setting of the interaction event, and the sound response played by the previous interaction content after executing the corresponding instruction guides the default object to move the setting object to the interaction area corresponding to the latter interaction content.

In one embodiment, the reference object is a physical pad, the physical pad is one or more, the one or more physical pad includes an access code corresponding to the interaction event, the electronic device recognizes the access code to access the position information corresponding to each interaction area on the physical pad and sound information of each interaction content.

In one embodiment, in the step of playing execution, when the electronic device executes the preset instruction to play the sound response, if the setting object is detected to move according to a preset trajectory, the electronic device generates a playing control signal, the electronic device controls the playing of the sound response according to the playing control signal, and/or switches the interaction event.

In one embodiment, the physical pad has a plurality of visible lattices on the surface, the position of each lattice corresponds to one of the interaction areas, and the corresponding interaction content is displayed in each lattice.

In one embodiment, in the step of movement detection, if the setting object stays outside the range of the interaction area for a predetermined time in the real-time image, the electronic device triggers a guiding signal, and plays a guiding sound to move to the interaction area according to the guiding signal.

The present disclosure further provides a non-transitory computer-readable recording medium of the above method.

The present disclosure further provides an electronic device for executing an interaction control detection to a setting object in a real-time image, including: a photographic unit, for taking images; an intelligent recognition unit, electrically connected with the photographic unit, and recognizing a real-time image including a default object, a reference object and a setting object; and an intelligent processing unit, the intelligent processing unit is electrically connected with the photographic unit and/or the intelligent recognition unit to read the real-time image, and reads an executable code and executes it, the intelligent processing unit includes: an interaction area setting module, setting a plurality of interaction areas according to the range occupied by the reference object in the real-time image, and each interaction area corresponds to an interaction content; a movement detection module, recognizing the default object holding the setting object in the real-time image with artificial intelligence, and detecting the movement of the setting object between the plurality of interaction areas on the reference object, and when the movement meets a preset condition, the electronic device triggers a preset instruction corresponding to the interaction content; and a playing execution module, executing the preset instruction for playing a sound response.

In one embodiment, the intelligent processing unit includes an event setting module, which is electrically connected with the interaction area setting module, the movement detection module and the playing execution module, the event setting module sets an interaction event to connect a plurality of interaction contents with relevance in series, the preset instructions corresponding to the plurality of interaction contents with relevance are triggered sequentially or randomly according to the setting of the interaction event, and the sound response played by the previous interaction content after executing the corresponding instruction guides the default object to move the setting object to the interaction area corresponding to the latter interaction content.

In one embodiment, the electronic device further includes a preset trajectory database, the preset trajectory database may store a plurality of preset trajectories through setting, when the setting object is detected that the movement trajectory meets any one of the preset trajectories, the electronic device generates a playing control signal, the electronic device controls the playing of the sound response according to the playing control signal, and/or switches the interaction event.

In one embodiment, the default object includes a child, the setting object includes a doll, and the intelligent recognition unit further includes a default object recognition module, a reference object recognition module and a setting object recognition module; wherein, the reference object recognition module is used to recognize the setting object in the real-time image.

The present disclosure further provides a terminal device in communication with the electronic device, the terminal device is equipped with an application program, the terminal device executes the application program to connect with the electronic device by communication, wherein the terminal device provides a user interface when executing the application program, and the user can set the interaction content and/or play the sound response through the user interface.

Accordingly, the electronic device of the present disclosure performs image recognition through artificial intelligence by executing the interaction control method, and when it recognizes that a default object holds a setting object in a real-time image, it can detect the movement of the setting object between a plurality of interaction areas on the reference object, and when the movement of the setting object meets the preset condition, the electronic device triggers and executes a preset instruction for playing a sound response, so that the setting object is systematically integrated with the reference object and fits in the interaction content of the set interaction area, so that the interaction effect when the default object holds the setting object is more vivid and interesting.

Furthermore, the interaction control method can set different interaction events through the step of event setting, and automatically execute the interaction events by recognizing the access code of the reference object, so that the interaction content can be variable; each interaction event may be a plurality of interaction contents with relevance connected in series, and the connection between the plurality of interaction contents is guided by the movement of the setting object, this also allows the default object to be more fitted into the interaction events, thereby achieving an immersive interaction effect.

### BRIEF DESCRIPTION OF THE DRAWINGS

FIG. 1 is a flow chart of main steps of a method of an embodiment of the present disclosure.

FIG. 2 is a block diagram of an electronic device executing the method of FIG. 1.

FIG. 3 is a schematic view of the electronic device in communication with the terminal device through the Internet to transmit a real-time image of the embodiment of the present disclosure.

FIG. 4 is a schematic view of the terminal device remotely receiving the real-time image taken by a photographic unit of the embodiment of the present disclosure.

FIG. 5A to FIG. 5D are schematic views of moving a doll to realize playing control of the embodiment of the present disclosure.

FIG. 6A to FIG. 6C are schematic plan views of physical pads of the embodiment of the present disclosure.

FIG. 7 is a block diagram illustrating the process V of the embodiment of the present disclosure.

FIG. 8 is a block diagram illustrating the process W of the embodiment of the present disclosure.

FIG. 9 is a block diagram illustrating the process X of the embodiment of the present disclosure.

FIG. 10 is a block diagram illustrating the process Y of the embodiment of the present disclosure.

FIG. 11 is a block diagram illustrating the process Z of the embodiment of the present disclosure.

FIG. 12 is a schematic view illustrating a state of use of a first embodiment of the present disclosure.

FIG. 13 is a schematic view illustrating a state of use of a second embodiment of the present disclosure.

FIG. 14 is a schematic view illustrating a state of use of a third embodiment of the present disclosure.

FIG. 15 to FIG. 18 are schematic views illustrating a state of use of a fourth embodiment of the present disclosure.

### DETAILED DESCRIPTION OF THE INVENTION

To facilitate understanding of the objectives, characteristics and effects of the present disclosure, specific embodiments together with the attached drawings for the detailed description of the present disclosure are provided as below.

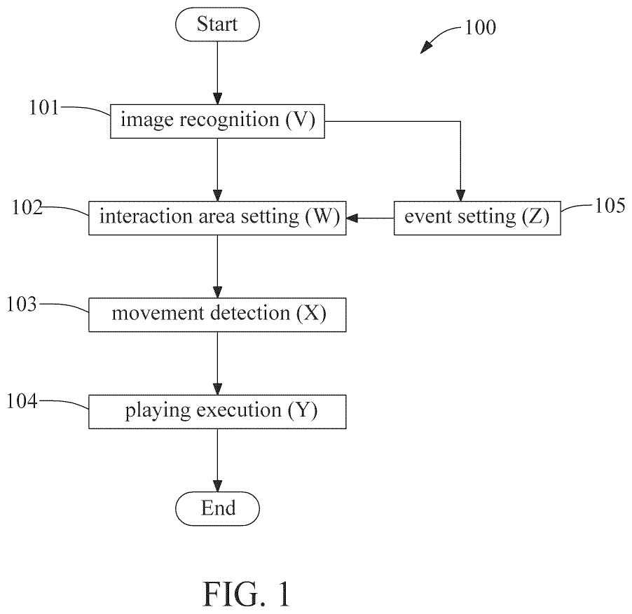

Referring to FIGS. 1 to 18, the present disclosure provides an interaction control method 100 for detecting a setting object in a real-time image, an electronic device 200 and a terminal device 300 connected to the electronic device 200, and a non-transitory computer-readable recording medium storing an executable code, wherein:

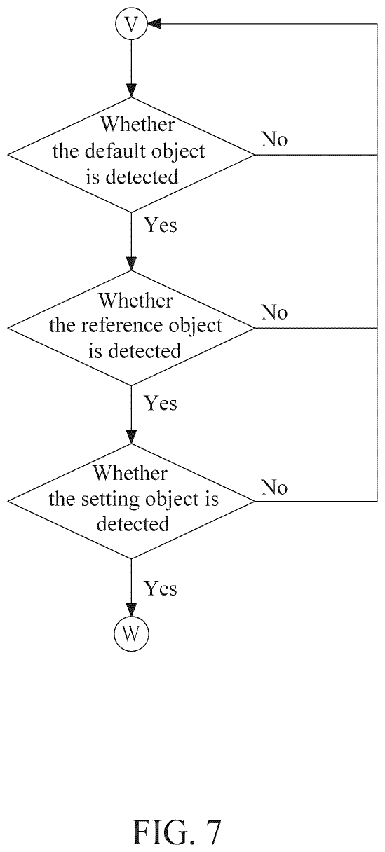

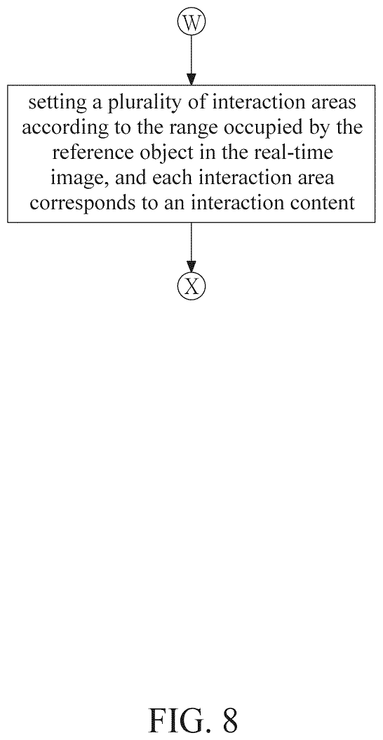

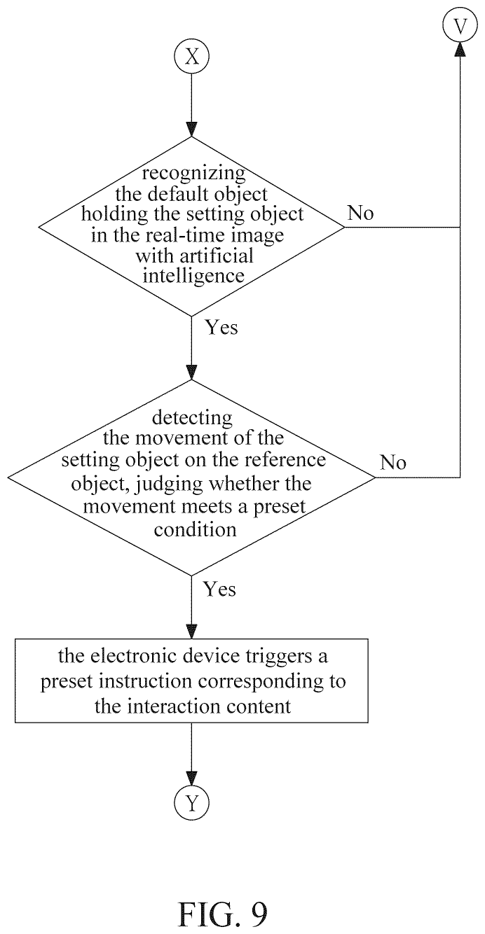

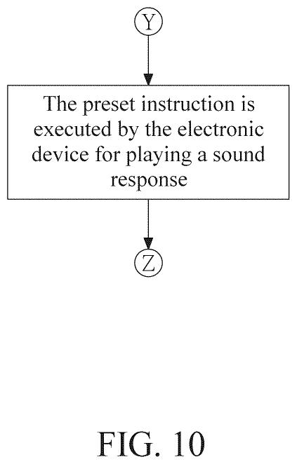

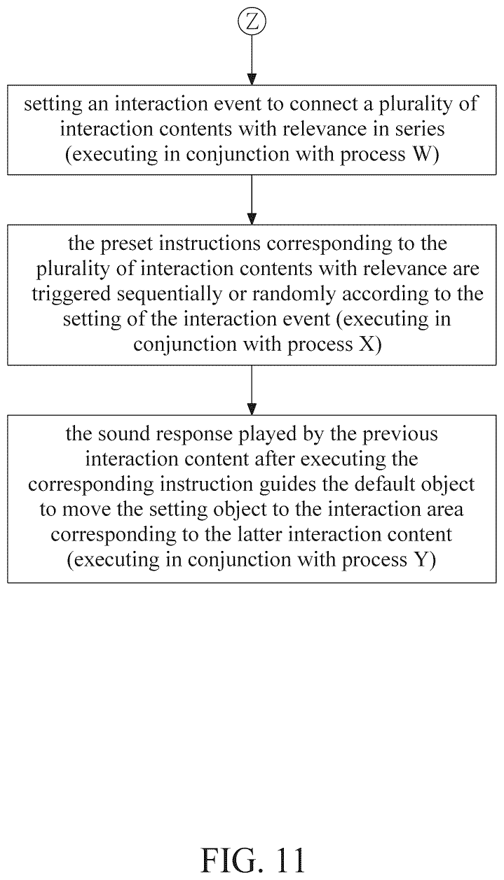

The interaction control method 100 executes steps of image recognition 101 (in FIG. 1 and indicating the process V to correspond to FIG. 7), interaction area setting 102 (in FIG. 1 and indicating the process W to correspond to the FIG. 8), movement detection 103 (in FIG. 1 and indicating the process X to correspond to the FIG. 9), and playing execution 104 (in FIG. 1 and indicating the process Y to correspond to the FIG. 10) as shown in an embodiment of FIG. 1 by an electronic device 200 reading the executable code, and further includes a step of event setting 105 (in FIG. 1 and indicating the process Z to correspond to the FIG. 11) in one embodiment.

A plurality of executable codes executed by the interaction control method 100 may be stored in the non-transitory computer-readable recording medium, so that after the electronic device 200 reads the executable codes from the non-transitory computer-readable recording medium, the electronic device executes them.

In one embodiment, the electronic device 200 executing the interaction control method 100 includes a photographic unit 400, an intelligent recognition unit 500 and an intelligent processing unit 600, the photographic unit 400 is electrically connected with the intelligent recognition unit 500, and the photographic unit 400 and the intelligent recognition unit 500 are electrically connected with the intelligent processing unit 600, and a real-time image V1 to be detected is obtained by the photographic unit 400 shooting. In one embodiment, the intelligent recognition unit 500 is suitable for executing the step of image recognition 101, including a default object recognition module 501 suitable for executing the recognition of a default object, a reference object recognition module 502 suitable for executing the recognition of a reference object, and a setting object recognition module 503 for recognizing a setting object in the real-time image V1. The intelligent processing unit 600 includes an interaction area setting module 601 suitable for executing the step of interaction area setting 102, a movement detection module 602 is suitable for executing the step of movement detection 103, and a playing execution module 603 suitable for executing the step of playing execution 104, and the intelligent processing unit 600 further includes an event setting module 604 in an embodiment, which is suitable for executing the step of event setting 105.

Continuously, the electronic device 200 is a physical host in an embodiment, and the intelligent recognition unit 500 and the intelligent processing unit 600 are disposed in the same body with the photographic unit 400 that is electrically connected thereto, but the present disclosure is not limited thereto, for example, the electronic device 200 may be a cloud host in an embodiment, and the intelligent recognition unit 500 and the intelligent processing unit 600 included therein remotely execute the steps including the image recognition 101, the interaction area setting 102, the movement detection 103, the playing execution 104 and/or the event setting 105.

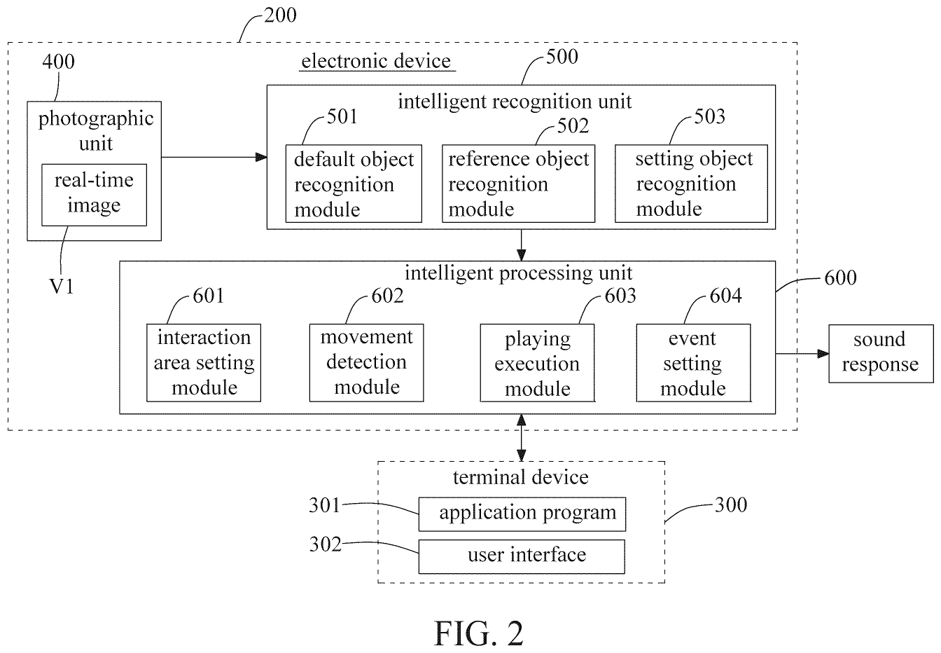

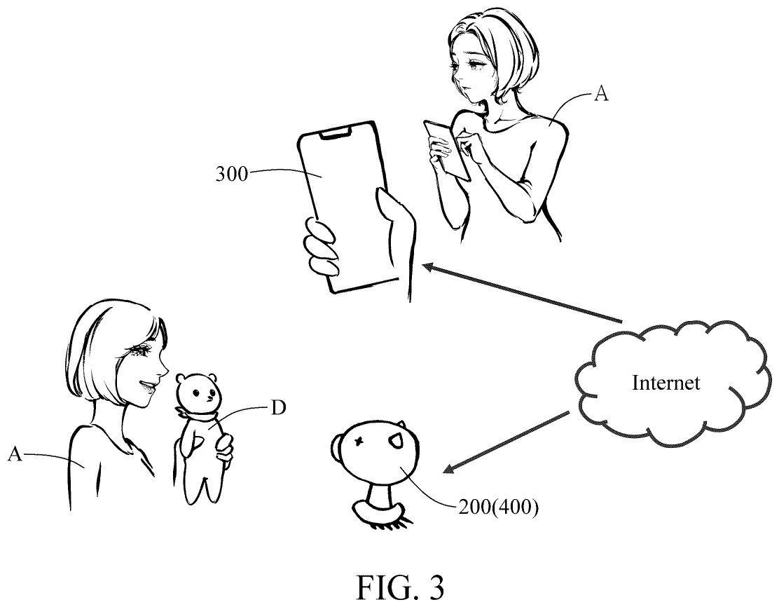

The terminal device 300 may be a portable mobile communication device, such as smart phone, or tablet computer, notebook computer, and can be in communication with the electronic device 200 through the Internet in a wired or wireless mode (referring to FIG. 3 together). The terminal device 300 is equipped with an application program 301 (referring to FIG. 2 together), the application program 301 is executed through the terminal device 300 to be in communication with the electronic device 200, wherein the terminal device 300 provides a user interface 302 when the application program 301 is executed, and the user can execute the steps of interaction area setting 102 and/or playing execution 104 through the user interface 302.

The photographic unit 400 is a camera used for monitoring children in an embodiment, and the real-time image V1 is an image that the photographic unit 400 takes pictures of children in real time. In an embodiment, the photographic unit 400 is mounted on a bracket 401 and located at a certain height, so that the range of the real-time image V1 can at least cover the reference object, and then cover the recognized default object, reference object and setting object.

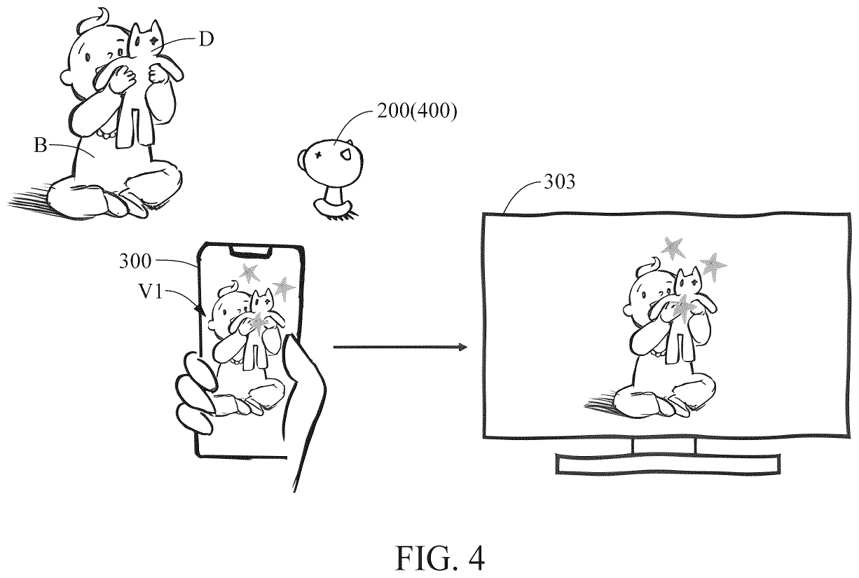

The default object includes adult A as shown in FIG. 3 and child B as shown in FIG. 4 in one embodiment; the setting object is doll D in one embodiment, but the present disclosure is not limited thereto, such as toys, teaching aids, or objects that children like. As shown in FIG. 3, adult A holds doll D for image recognition by the photographic unit 400, and is in communication with the terminal device 300 through the Internet. Adult A can edit remotely through the terminal device 300. Also, as shown in FIG. 4, when child B holds doll D, the photographic unit 400 can transmit the real-time image V1 that is taken thereby to the terminal device 300 through the aforementioned Internet, and carry out simple image editing (for example, adding “star” in the figure), and the terminal device 300 can be connected with the display 303 and display the edited image together.

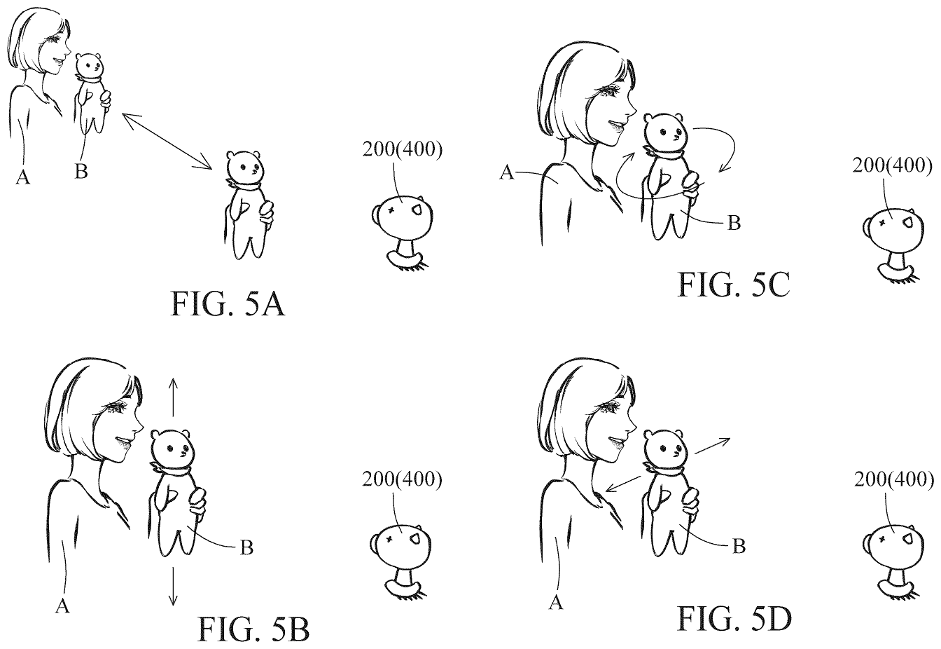

In the step of playing execution 104, when the electronic device 200 executes the preset instruction to play the sound response, such as a piece of music or a story, if the setting object is detected to move according to a preset trajectory, the electronic device 200 generates a playing control signal, and the electronic device 200 controls the playing of the sound response according to the playing control signal, and/or switches the interaction event. In an embodiment, playing, pausing playing, playing the previous or next song, and stopping playing may be set according to the movement trajectory of doll D, for example, when the photographic unit 400 captures the movement of doll D as “moving back and forth”, the function of “playing” is executed (as shown in FIG. 5A); when the photographic unit 400 captures the movement of doll D as “moving up and down”, the function of “pausing playing” is executed (as shown in FIG. 5B); when photographic unit 400 captures the movement of doll D as “moving in a circle”, the function of “playing the previous song (e.g., circling clockwise)” or “playing the next song (e.g., circling counterclockwise)” is executed (as shown in FIG. 5C); then, when the photographic unit 400 captures the movement of doll D as “moving left and right”, the function of “stopping playing” is executed (as shown in FIG. 5D). The movement trajectory and the corresponding playing function can be changed by setting according to the actual application needs, so that the playing control can be used more easily and flexibly.

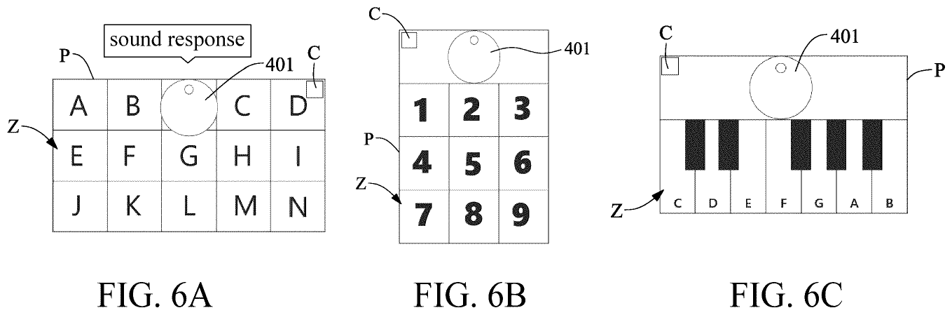

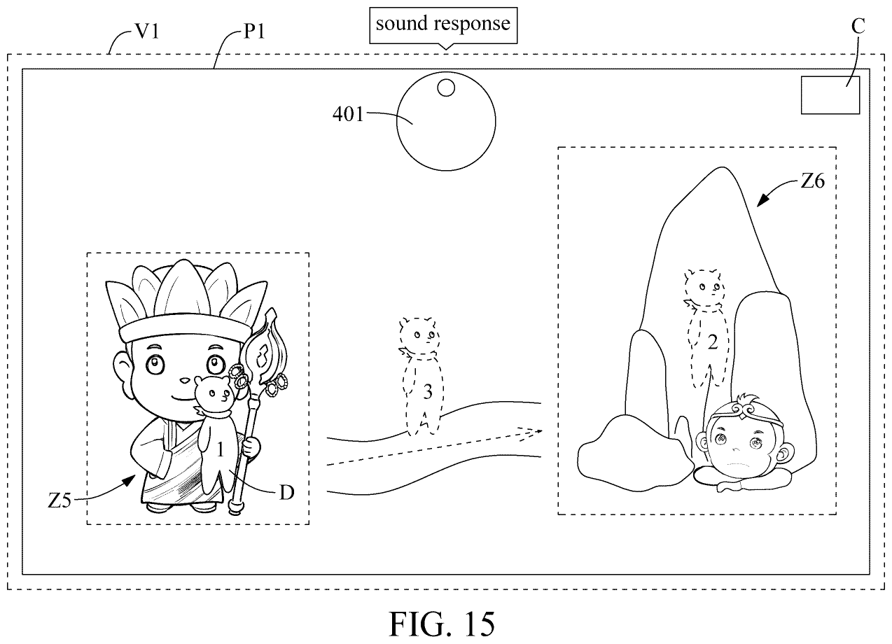

The reference object is a physical pad P in an embodiment, the physical pad P has a plurality of visible lattices on the surface for example, the position of each lattice corresponds to an interaction area Z, and the corresponding interaction content is displayed in each lattice, such as English letters shown in FIG. 6A, numerals shown in FIG. 6B, or musical scales shown in FIG. 6C, these physical pads P have an access code C individually, and the access code C is a QR CODE for example; The interaction content of each physical pad P, the position information and sound information of the interaction area Z where it is located, may be stored in a database (not shown in the figure), and when the photographic unit 400 recognizes the access code C of a certain physical pad P, the electronic device 200 accesses the position information corresponding to each interaction area Z on the physical pad P from the database, and the sound information of each interaction content. Furthermore, the physical pad may also be a group of multiple (referring to the physical pads P1-P4 shown in FIG. 15 to FIG. 18 together), and the four physical pads of the same group may include a corresponding access code according to an interaction event (referring to the access codes C1-C4 shown in FIG. 15 to FIG. 18 together), and then are replaced in a sequential or random manner.

Regarding the execution of the interaction control method 100, when executing the step of image recognition 101, referring to the process V shown in FIG. 7 together, the intelligent recognition unit 500 recognizes whether there is a default object, a reference object and a setting object in the real-time image V1 with artificial intelligence. When the intelligent recognition unit 500 recognizes that there is the default object, the reference object and the setting object from the real-time image V1 (i.e., all three are present), then the interaction area setting 102 is executed.

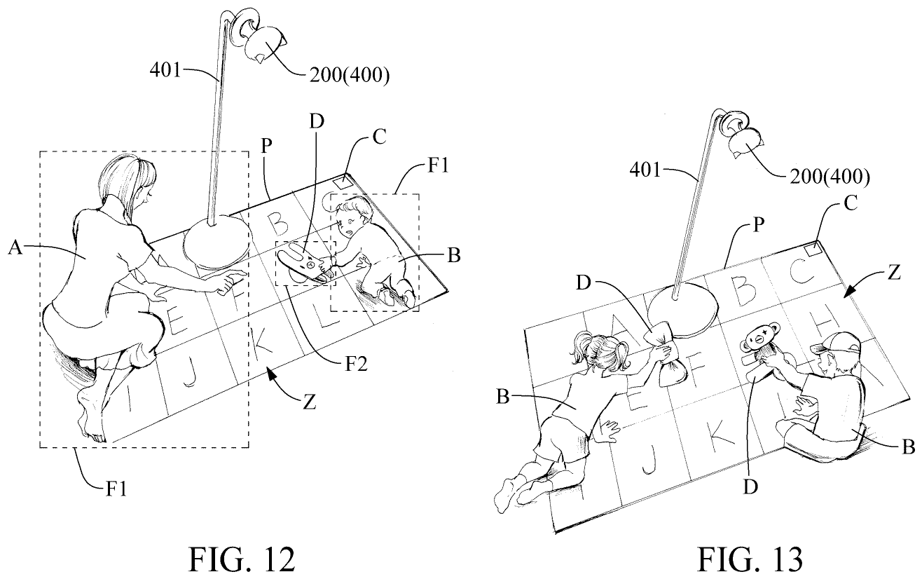

Continuously, when there is a default object recognized, a first target frame F1 covering the default object is defined; when there is a setting object recognized, a second target frame F2 covering the setting object is defined. As shown in FIG. 12, the default object includes adult A and child B, wherein adult A defines the first target frame F1, and child B also defines a first target frame F1, and doll D defines a second target frame F2, and the movements of adult A, child B and doll D are detected with the first target frame F1 and the second target frame F2.

When executing the step of interaction area setting 102, referring to the process W shown in FIG. 8 together, the electronic device 200 sets a plurality of interaction areas Z according to the range occupied by the reference object in the real-time image V1 (referring to FIGS. 6A-6C together), and each interaction area Z corresponds to an interaction content, and the detailed embodiment of the interaction area Z and the interaction content is described as follows. After executing the step of interaction area setting 102, the step of movement detection 103 is executed.

When executing the step of movement detection 103, referring to the process X shown in FIG. 9 together, it is to recognize the default object holding the setting object in the real-time image V1 with artificial intelligence, and detect the movement of the setting object on the reference object, and when the movement meets a preset condition, the electronic device 200 triggers a preset instruction corresponding to the interaction content. In an embodiment, the step of movement detection 103 is to confirm that the default object holds the setting object in the real-time image V1 when the first target frame F1 and the second target frame F2 intersect, and the movement of the setting object is detecting a movement trajectory of a center point of the second target frame F2, and includes detecting a relative change in the area size of the second target frame F2.

When executing the step of playing execution 104, referring to the process Y shown in FIG. 10 together, the preset instruction is executed by the electronic device 200 for playing a sound response, and the sound response described here may be a simple sound effect, such as an animal sound, a nature sound (such as rain, thunder), and a musical instrument playing sound. Furthermore, the sound response may also be a voice that describes words or patterns, and the word is like a voice that plays a numeral or an English letter, such as a voice that plays the numeral “1” or the English letter “A”, and the same is true for various symbols; the sound response corresponding to the pattern is such as color, shape, animals in the land, sea and air, insects, vegetables and fruits, daily necessities, vehicles, occupations, weather, such as playing “red”, “round”, “dog”, and so on. In addition, the sound response may also be the content of a story, or a piece of music.

In an embodiment, as shown in FIG. 1, the interaction control method 100 further includes a step of event setting 105, and the event setting 105 is executed after the step of image recognition 101 and before the step of interaction area setting 102. Also, as shown in FIG. 11, the step of event setting 105 is setting an interaction event to connect a plurality of interaction contents with relevance in series, the preset instructions corresponding to the plurality of interaction contents with relevance are triggered sequentially or randomly according to the setting of the interaction event, and the sound response played by the previous interaction content after executing the corresponding instruction guides the default object to move the setting object to the interaction area Z corresponding to the latter interaction content.

According to the description of the above embodiment, the specific embodiment of the electronic device 200 executing the interaction control method 100 of the present disclosure is further illustrated as follows:

The first embodiment of the present disclosure is shown in FIG. 12, the default object in the figure includes a child B and an adult A, the reference object is a physical pad P, the setting object is the doll D held by the child B, and the photographic unit 400 is erected above the physical pad P through the bracket 401, and the corresponding interaction content displayed in each lattice is the English letters A to M. In the scenario, the interaction control method 100 is executed, firstly the step of image recognition 101 is carried out by the intelligent recognition unit 500, so as to recognize that there is a child B and an adult A and individually define the first target frame F1, and recognize that there is a doll D and define the second target frame F2, and scan the access code C (QR CODE) of the physical pad P from the real-time image V1, and then access the position information of the interaction area Z and the sound information of the interaction content.

In the embodiment, the step of interaction area setting 102 is setting the interaction content in each interaction area Z to play the voice corresponding to the English letter shown. Next, the step of movement detection 103 is executed, that is, it recognizes the child B holding the doll D in the real-time image V1 with artificial intelligence as shown on the physical pad P, and detects the movement of the doll D on the physical pad P, when the doll D is detected to move from an interactive area Z to another interactive area Z and stay for a predetermined time (for example, 2 seconds), the corresponding interaction content is triggered by the electronic device 200. For example, the doll D in FIG. 12 is detected to move from the interaction area Z of “L” to the interaction area Z of “G”, and the doll D stays in the interaction area Z of “G” for 2 seconds or more, the movement of the doll D is regarded to meet the preset condition at this moment, and the electronic device 200 triggers a preset instruction corresponding to the interaction content “G”. Next, the step of playing execution 104 is executed, that is, it plays the voice of “G” as a sound response, so as to guide the child B to understand that the English letter in the lattice where the doll D is located is pronounced as “G”.

As shown in FIG. 13, it is the second embodiment of the present disclosure, it is the same as the first embodiment in the interaction area Z formed by a plurality of lattices visible on the surface of the physical pad P, and there are English letters A to M in each interaction area Z, it is different from the first embodiment in that the two default objects in the figure are children B, and both children B are holding dolls D, and through the execution of the interaction control method 100 of the first embodiment, two children B are guided to understand the pronunciations of the English letters in the interaction area Z where the doll D is located in their hands.

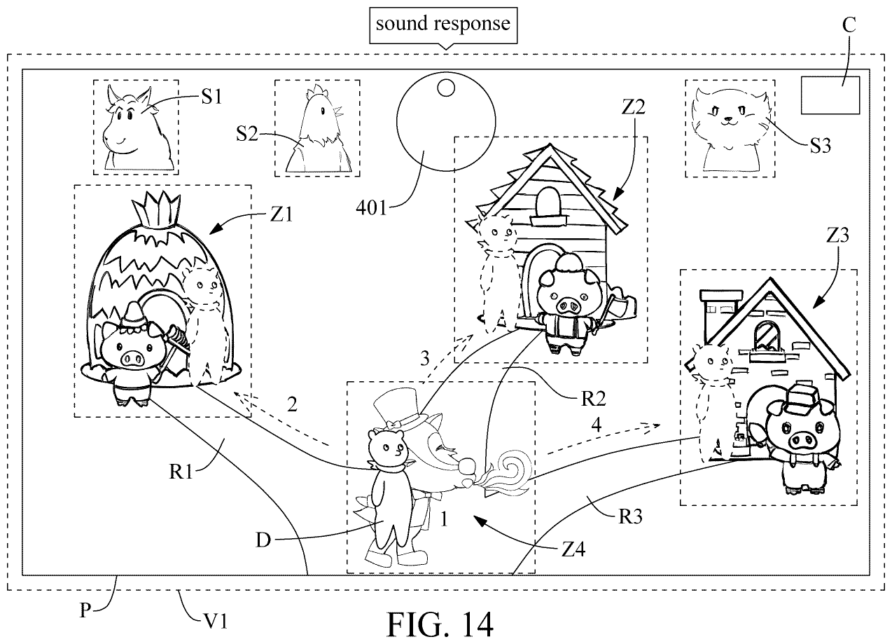

As shown in FIG. 14, it is the third embodiment of the present disclosure, wherein the default object is a child (not shown in the figure), the reference object is a physical pad P, and the setting object is a doll D, and the scenario in FIG. 14 is to tell the story of “big wild wolf”. The step of image recognition 101 in the interaction control method 100 of the present embodiment is basically the same as that of the first embodiment, so it can refer to the description of the first embodiment, and the step of the interaction area setting 102 includes setting the interaction area Z1 for the interaction content of the first little pig and the straw house pattern thereof, the interaction area Z2 for the interaction content of the second little pig and the wooden house pattern thereof, the interaction area Z3 for the interaction content for the third little pig and the brick house pattern thereof, and the interaction area Z4 corresponding to the interaction content of the big wild wolf. Then, the steps of movement detection 103 and playing execution 104 are executed, for example, when the doll D is placed in interaction area Z1 and stays for 2 seconds, the narration “the first little pig decides to build a house with straw” of the first little pig building a straw house is played as the sound response, when the doll D is placed in interaction area Z2 and stays for 2 seconds, the narration “the second little pig decides to build a house with wood” of the second little pig building a wooden house is played as the sound response, when the doll D is placed in interaction area Z3 and stays for 2 seconds, the narration “the third little pig decides to build a house with brick” of the third little pig building a brick house is played as the sound response, and when the doll D is placed in interaction area Z4 and stays for 2 seconds, the narration “the big wild wolf says he is hungry and wants to eat little pigs” of the big wild wolf wants to catch little pigs is played as the sound response.

Continuously, in the third embodiment, the step of movement detection 103 also includes detecting that when the setting object has been moved from the first interaction area Z to another interaction area Z, for example, the doll D is moved from the interaction area Z4 to the interaction area Z1, simulating the big wild wolf to find the residence of the first little pig along the path R1, and playing the narration “the big wild wolf gave a puff and blows the straw house down” of the big wild wolf destroying the straw house as a sound response in the step of playing execution 104; another example is that the doll D is moved from the interaction area Z4 to the interaction area Z2, simulating the big wild wolf to find the residence of the second little pig along the path R2, and playing the narration “the big wild wolf knocked the wooden house down as soon as he exerted himself” of the big wild wolf destroying the wooden house as a sound response in the step of playing execution 104; another example is that the doll D is moved from the interaction area Z4 to the interaction area Z3, simulating the big wild wolf to find the residence of the third little pig along the path R3, and playing the narration “the big wolf could not destroy the brick house, it failed” of the big wolf destroying the brick house as a sound response in the step of playing execution 104; or, suppose that after the doll D is moved on the physical pad P, the position where it stays is outside the interaction areas Z1-Z4, for example, it stays on the road (marked as paths 1-3), then the step of playing execution 104 plays “you are lost” as a sound response, so as to guide child B to move the doll D within the interaction areas Z1-Z4. The movement of the doll D on the physical pad P may be in the order from numerals 1 to 4 as shown in FIG. 14, or it may move randomly without following the order. Thus, child B can move the doll D on the physical pad P, and the position of doll D can be detected by the electronic device 200, such as being located in the interaction areas Z1-Z4, or being located on the road between the interaction areas Z1-Z4, and the movement of doll D (paths 1-3) may also be detected, so as to play the corresponding interaction content, so that child B can feel the story scenario of “big wild wolf” in an immersive manner.

In addition, the user interface 302 of the terminal device 300 may also display information related to the interaction content correspondingly, and adult A can play the corresponding sound effect through the control element (such as touch screen) on the terminal device 300, for example, click the interaction area Z1 and can play the sound of straws rubbing together when the first little pig builds the straw house through the electronic device 200, and so on, thereby increasing the content richness of the interaction process of child B. In addition, in addition to having interaction areas Z1-Z4 and the corresponding interaction contents thereon, the physical pad P may also be interspersed with passers-by S1-S3 as shown in FIG. 14 when the step of interaction area setting 102 is executed, and there are more characters, and an interaction area Z and corresponding interaction content (such as cow moo, cock crow and cat meow) may also be set to randomly trigger, so as to make the interaction content richer.

Also, as shown in FIG. 15 to FIG. 18, they describe the fourth embodiment of the present disclosure, the scenarios of the present embodiment and the third embodiment are also telling a story, wherein the default object is also a child (not shown in the figure), and the setting object is the same doll D, but the difference is that the third embodiment only uses one physical pad P, while the fourth embodiment uses four physical pads P1-P4 replaced in sequence, which respectively tell four scenarios of the story of “Journey to the West”, and each physical pad P1-P4 has individual access code C1-C4 to access the position information of the individual interaction area Z, as well as the sound information corresponding to the interaction content.

The first physical pad P1 shown in FIG. 15 describes the scenario of Tang Sanzang going to Wuzhi Mountain to rescue Sun Wukong. When the doll D is moved to the interaction area Z5 where Tang Sanzang is located (the position of the numeral 1), the narration “Tang Sanzang came to the Five Elements Mountain” is played as the sound response, when the doll D is moved to the interaction area Z6 where Sun Wukong is located (the position of the numeral 2), the narration “Sun Wukong is trapped under the Five Elements Mountain” is played as the sound response, and when the doll D is moved from the interaction area Z5 to the interaction area Z6 (the position of the numeral 3), the narration “Tang Sanzang rescued Sun Wukong” is played as the sound response.

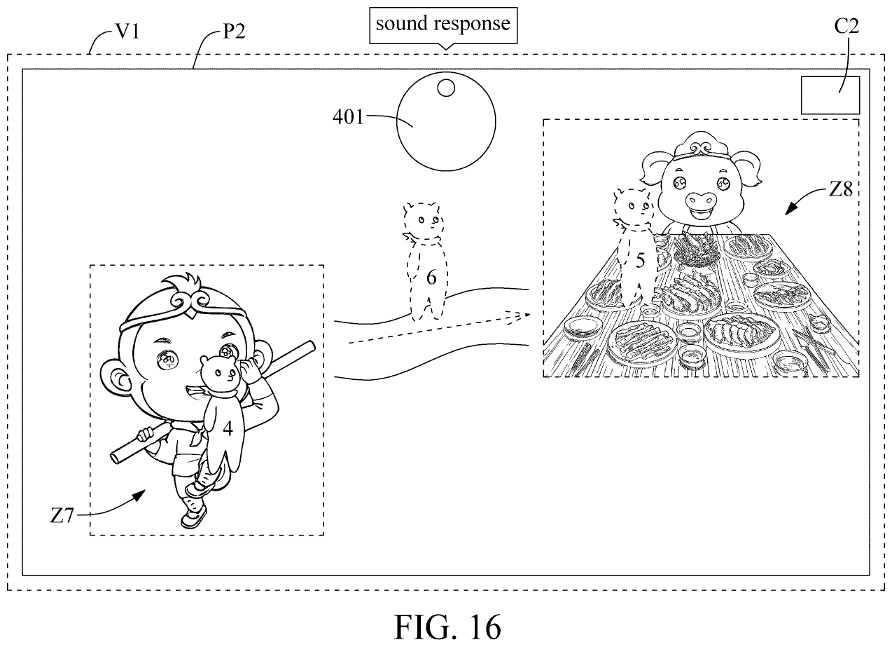

The physical pad P2 shown in FIG. 16 describes the scenario of Sun Wukong subduing Zhu Bajie. When the doll D is moved to the interaction area Z7 where Sun Wukong is located (the position of numeral 4), the narration “Sun Wukong saw Zhu Bajie” is played as the sound response, when the doll D is moved to the interaction area Z8 where Zhu Bajie is located (the position of numeral 5), the narration “Zhu Bajie forcibly occupied private houses” is played as the sound response, and when the doll D is moved from the interaction area Z7 to the interaction area Z8 (the position of numeral 6), the narration “Sun Wukong is ready to subdue Zhu Bajie” is played as the sound response.

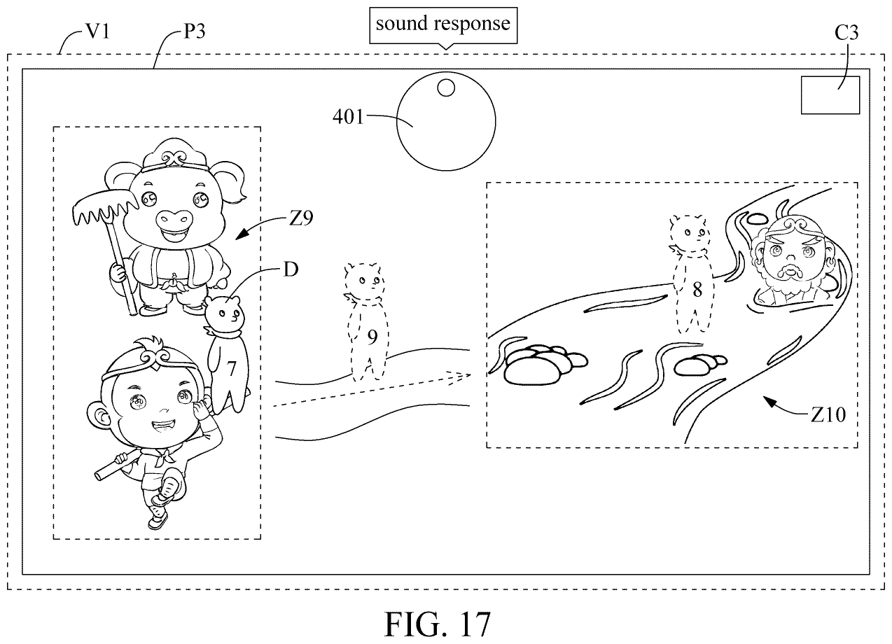

The physical pad P3 shown in FIG. 17 describes the scenario of Sun Wukong subduing Sha Wujing. When the doll D is moved to the interaction area Z9 where Sun Wukong and Zhu Bajie are located (the position of numeral 7), the narration “Sun Wukong and Zhu Bajie saw Sha Wujing” is played as the sound response, when the doll D is moved to the interaction area Z10 where Sha Wujing is located (the position of numeral 8), the narration “Sha Wujing appeared in the Flowing Sands River” is played as the sound response, and when the doll D is moved from the interaction area Z9 to the interaction area Z10 (the position of numeral 9), the narration “Sun Wukong and Zhu Bajie are ready to subdue Sha Wujing” is played as the sound response.

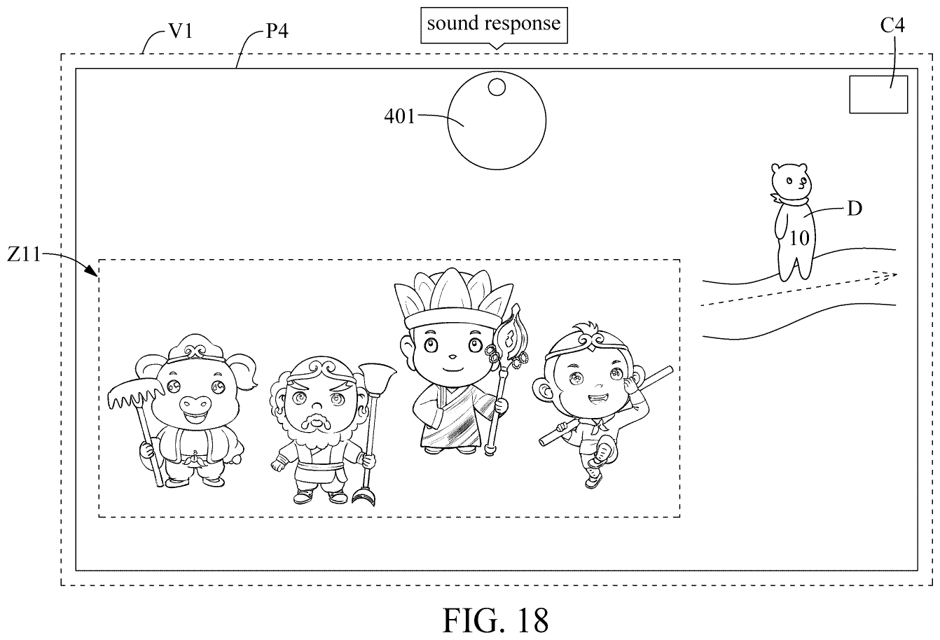

The physical pad P4 shown in FIG. 18 describes the scenario that the master Tang Sanzang and three apprentices went to the West to obtain scriptures, at this time, when the doll D is moved to the interaction area Z11 where the master Tang Sanzang and three apprentices are located (the position of the numeral 10), the narration “Tang Sanzang finally subdued Sun Wukong, Zhu Bajie and Sha Wujing” is played as the sound response, and when the doll D is moved from the interaction area Z11 to the path of the West, the narration “the master Tang Sanzang and three apprentices began to go to the West to obtain scriptures” is played as the sound response. The movement of the doll D on the physical pad P in FIGS. 15-18 may be in order, such as in the order from numerals 1 to 10 as shown in FIGS. 15-18, or it may move randomly without following the order.

From the above explanation, it is not difficult to find that the characteristic of the present disclosure is that the interaction control method 100 of the present disclosure is executed by the electronic device 200 reading an executable code, the executable code is stored by a non-transient computer-readable recording medium, the electronic device 200 is in communication with the terminal device 300, through the executions of the image recognition 101, the interaction area setting 102, the movement detection 103, and the playing execution 104, it can detect the movement of the setting object between a plurality of interaction zones Z on the reference object in the real-time image V1, and when the movement of the setting object meets the preset condition, the electronic device 200 triggers and executes the preset instruction for playing the sound response, so that the setting object is systematically integrated with the reference object and fits in the interaction content of the set interaction area, so that the interaction effect when the default object holds the setting object is more vivid and interesting, thereby meeting the user's expectation.

Furthermore, the interaction control method 100 of the present disclosure further includes the step of event setting, which can set different interaction events, and automatically execute the interaction events by recognizing the access code C of the reference object, so that the interaction content can be variable, wherein each interaction event may be a plurality of interaction contents with relevance connected in series (such as the story telling of the third and fourth embodiments), and the connection between the plurality of interaction contents is guided by the movement of the setting object, this also allows the default object to be more fitted into the interaction events, thereby achieving an immersive interaction effect and meeting the user's expectation.

While the present invention has been described by means of preferable embodiments, those skilled in the art should understand the above description is merely embodiments of the invention, and it should not be considered to limit the scope of the invention. It should be noted that all changes and substitutions which come within the meaning and range of equivalency of the embodiments are intended to be embraced in the scope of the invention. Therefore, the scope of the invention is defined by the claims.

What is claimed is:

1. An interaction control method for detecting a setting object in a real-time image, executed by an electronic device reading an executable code, and executing the following steps:
image recognition: recognizing a default object, a reference object and a setting object at the same time by artificial intelligence in the real-time image taken by a photographic unit of the electronic device;
interaction area setting: setting a plurality of interaction areas according to the range occupied by the reference object in the real-time image by the electronic device, and each interaction area corresponds to an interaction content;
movement detection: recognizing the default object holding the setting object in the real-time image with artificial intelligence, and detecting the movement of the setting object between the plurality of interaction areas on the reference object, and when the movement meets a preset condition, the electronic device triggers a preset instruction corresponding to the interaction content; and
playing execution: executing the preset instruction by the electronic device for playing a sound response.

2. The interaction control method according to claim 1, wherein in the step of image recognition, a first target frame covering the default object is defined, and a second target frame covering the setting object is defined; in the step of movement detection, when the first target frame and the second target frame intersect, the default object is confirmed to hold the setting object in the real-time image, and the movement of the setting object is detecting a movement trajectory of a center point of the second target frame, and comprises detecting a relative change in the area size of the second target frame.

3. The interaction control method according to claim 2, wherein in the step of movement detection, when the setting object is detected to have a movement from one of the interaction areas to another one of the interaction areas, or is detected to move from one of the interaction areas to another one of the interaction areas and stay for a predetermined time, it is regarded to meet the preset condition.

4. The interaction control method according to claim 3, further comprising a step of event setting, the step of event setting is setting an interaction event to connect a plurality of interaction contents with relevance in series, the preset instructions corresponding to the plurality of interaction contents with relevance are triggered sequentially or randomly according to the setting of the interaction event, and the sound response played by the previous interaction content after executing the corresponding instruction guides the default object to move the setting object to the interaction area corresponding to the latter interaction content.

5. The interaction control method according to claim 4, wherein the reference object is a physical pad, the physical pad is one or more, the one or more physical pad comprises an access code corresponding to the interaction event, the electronic device recognizes the access code to access the position information corresponding to each interaction area on the physical pad and sound information of each interaction content.

6. The interaction control method according to claim 3, wherein in the step of playing execution, when the electronic device executes the preset instruction to play the sound response, if the setting object is detected to move according to a preset trajectory, the electronic device generates a playing control signal, the electronic device controls the playing of the sound response according to the playing control signal, and/or switches the interaction event.

7. The interaction control method according to claim 5, wherein the physical pad has a plurality of visible lattices on the surface, the position of each lattice corresponds to one of the interaction areas, and the corresponding interaction content is displayed in each lattice.

8. The interaction control method according to claim 4, wherein in the step of movement detection, if the setting object stays outside the range of the interaction area for a predetermined time in the real-time image, the electronic device triggers a guiding signal, and plays a guiding sound to move to the interaction area according to the guiding signal.

9. A terminal device in communication with the electronic device of claim 1, the terminal device is equipped with an application program, the terminal device executes the application program to connect with the electronic device by communication, wherein the terminal device provides a user interface when executing the application program, and the user can execute the steps of interaction area setting and/or playing execution through the user interface.

10. An electronic device for executing an interaction control detection to a setting object in a real-time image, comprising:
a photographic unit, for taking images;
an intelligent recognition unit, electrically connected with the photographic unit, and recognizing a real-time image comprising a default object, a reference object and a setting object; and
an intelligent processing unit, the intelligent processing unit is electrically connected with the photographic unit and/or the intelligent recognition unit to read the real-time image, and reads an executable code and executes it, the intelligent processing unit comprises:
an interaction area setting module, setting a plurality of interaction areas according to the range occupied by the reference object in the real-time image, and each interaction area corresponds to an interaction content;
a movement detection module, recognizing the default object holding the setting object in the real-time image with artificial intelligence, and detecting the movement of the setting object between the plurality of interaction areas on the reference object, and when the movement meets a preset condition, the electronic device triggers a preset instruction corresponding to the interaction content; and
a playing execution module, executing the preset instruction for playing a sound response.

11. The electronic device according to claim 10, wherein the intelligent processing unit comprises an event setting module, electrically connected with the interaction area setting module, the movement detection module and the playing execution module, the event setting module sets an interaction event to connect a plurality of interaction contents with relevance in series, the preset instructions corresponding to the plurality of interaction contents with relevance are triggered sequentially or randomly according to the setting of the interaction event, and the sound response played by the previous interaction content after executing the corresponding instruction guides the default object to move the setting object to the interaction area corresponding to the latter interaction content.

12. The electronic device according to claim 10, wherein the electronic device further comprises a preset trajectory database, the preset trajectory database can store a plurality of preset trajectories through setting, when the setting object is detected that the movement trajectory meets any one of the preset trajectories, the electronic device generates a playing control signal, the electronic device controls the playing of the sound response according to the playing control signal, and/or switches the interaction event.

13. The electronic device according to claim 10, wherein the default object comprises a child, the setting object comprises a doll, and the intelligent recognition unit further comprises a default object recognition module, a reference object recognition module and a setting object recognition module; wherein, the reference object recognition module is used to recognize the setting object in the real-time image.

14. A terminal device in communication with the electronic device according to claim 10, the terminal device is equipped with an application program, the terminal device executes the application program to connect with the electronic device by communication, wherein the terminal device provides a user interface when executing the application program, and the user can set the interaction content and/or play the sound response through the user interface.

15. A non-transitory computer-readable recording medium, storing a plurality of executable codes, an electronic device reads the executable codes, and executes the following steps, comprising:
image recognition: recognizing a default object, a reference object and a setting object at the same time by artificial intelligence in the real-time image taken by a photographic unit of the electronic device;
interaction area setting: setting a plurality of interaction areas according to the range occupied by the reference object in the real-time image by the electronic device, and each interaction area corresponds to an interaction content;
movement detection: recognizing the default object holding the setting object in the real-time image with artificial intelligence, and detecting the movement of the setting object between the plurality of interaction areas on the reference object, and when the movement meets a preset condition, the electronic device triggers a preset instruction corresponding to the interaction content; and
playing execution: executing the preset instruction by the electronic device for playing a sound response.
